(19) United States
(12) Patent Application Publication
(10) Pub. No.: US 2008/0068820 A1
(43) Pub. Date: Mar. 20, 2008

(54) LIGHTING STICK AND METHOD OF PROVIDING A SPECIAL EFFECT TO A TRADITIONAL DANCE

(75) Inventors: Rajesh Patel, Montreal (CA); Dhiren Patel, Montreal (CA)

Correspondence Address: BERESKIN AND PARR, 40 KING STREET WEST, BOX 401, TORONTO, ON, M5H 3Y2, US

(73) Assignee: MERA-MPYER DISTRIBUTIONS INC., Montreal (CA)

(21) Appl. No.: 11/858,202

(22) Filed: Sep. 20, 2007

Related U.S. Application Data
(60) Provisional application No. 60/826,279, filed on Sep. 20, 2006.

(51) Int. Cl. F21K 2/06; F21S 4/00

(52) U.S. Cl. 362/34; 362/217

(57) ABSTRACT

A light stick for use in a traditional dance comprising an elongated impact resistant body having an striking surface and at least one light source imbedded in the body. An electronic circuit for controlling the light source and a power source for powering the electronic circuit and the light source may also be incorporated in the body. The light source is placed set back the said striking surface. The electronic circuit and the power source are contained within the body. A method of providing a special effect to a traditional dance comprises the step of illuminating a surface of the impact-resistant stick with imbedded lights is also described.

### FIELD OF THE INVENTION

The present invention generally relates to the field of technological improvements to traditional arts. More specifically, the present invention relates to a novel method of lighting a surrounding during a traditional dance.

### BACKGROUND OF THE INVENTION

Many different traditional dances originate from all around the world. Originating in North India, Raas and Garba are the featured dances of the Navratri evenings. Navratri is a Hindu festival celebrated all over India. It lasts for nine consecutive nights and is meant to praise Lord Rama (Hero of the Epic Ramayana) and Goddess Durga. The Navratree, which means nine nights, festival typically extends from the end of September to the beginning of October.

This dance form, originating as devotional Garba dances, was performed in Durga's honor. The dance actually represents the staging of a mock-fight between the Goddess and Mahishasura, the mighty demon-king. This dance form is nicknamed “The Sword Dance” where sticks are used to represent the sword of Durga. For the dance, women wear traditional dresses such as colorful embroidered choli, ghagra and bandhani dupattas (traditional attire) decorated with mirrors jewellery. Men typically wear special turbans and kedias. The dancers whirl and move their feet and arms in a choreographed manner to the tune of the music. The musical instruments used typically include the dhol and percussion instruments such as the dholak and tabla. The complicated dance choreography gets very energetic. The Although somewhat similar, the Garba and Raas dances have different meanings: the Garba dance is performed before Aarti (worshipping ritual) as devotional performances in the honor of the Goddess while the Raas dance is performed after it, as a part of merriment. Garba is performed exclusively by women while women and men join in for Raas. Raas is also known as “The Dance of Swords”. The dancers use a pair of colorfully decorated sticks, the Dandiya stick, as symbols of the swords and perform circular movements which get even more complex than that of Garba. These dance performances seem to originate during the living years of Lord Krishna. Today, Raas is not only an important part of Navratri in Gujarat, a region of India, but is also part of other festivals celebrating harvest and crops (source: Wikipedia).

Traditionally, the colorfully decorated sticks are made of painted wood and are struck against each other during the dance. However, the sticks often get their paint chipped due to the repeated strikes. Their nice appearance is therefore damaged for the remaining of the festival and they need repainting to regain their original appearance.

There is therefore a clear need for improved Dandiya sticks that address the problems of the prior art.

### SUMMARY OF THE INVENTION

It is an object of the invention to provide a stick used in a traditional dance that solves the problems of prior art.

It is a further object of the invention to provide a Dandiya stick that does not get damaged when struck against another Dandiya stick and retains its nice appearance during a whole festival.

It is a further object of the invention to provide a Dandiya stick that has increased visibility.

It is a further object of the invention to provide a method of providing a special effect using lighting Dandiya sticks during a traditional dance.

In accordance with an embodiment of the present invention, there is provided a light stick for use in a traditional dance. The light stick comprises an elongated impact resistant body having a striking surface and at least one light source imbedded in the body, placed set back from the striking surface. The body is at least partly permeable to the light coming from the light source. Permeable to the light just means that the body is adapted to let the light fro the light source go through to the exterior such by being translucent or by being equipped with openings. The light source may either be chemiluminescent or electrical. In the later case, an electronic circuit for controlling the at least one light source and a power source for powering the electronic circuit and the at least one light source. The at least one light source is placed set back from the striking surface such as to not be damaged by the striking of two sticks together. The electronic circuit and the power source are contained within the body.

Preferably, the at least one light source is completely imbedded in the body. More preferably, the body comprises a solid striking portion. Most preferably, the body has a circular cross-section.

The light stick may optionally be equipped with a semi-transparent shade containing the at least one light source. The semi-transparent shade is used to diffuse the light from the light source. Preferably, the body of the light stick is at least partly made of polycarbonate, glass fiber, metal, wood or any combination thereof.

In accordance with another embodiment of the present invention, there is provided a method of providing a special effect to a traditional dance. The method comprises providing an impact-resistant lighting stick and illuminating the surface of the impact-resistant stick with imbedded lights. Preferably, the method further comprising the step of making the lighting stick flash. More preferably, the lights of the lighting stick flash in a pattern. Most preferably, the lights of the lighting stick are made to flash sequentially from a proximate end to a distal end of the stick.

The method also comprises the step of striking the stick against another similar stick. Preferably, the lighting sticks are made to flash on impact.

Advantageously, the Dandiya stick of the present invention does not get damaged when struck against another Dandiya stick and retains its nice appearance throughout a festival. Furthermore, the Dandiya stick of the present invention has an increased visibility, which further highlights its importance and also provides a nice ambiance during the dance.

### BRIEF DESCRIPTION OF DRAWINGS

These and other features of the present invention will become more apparent from the following description in which reference is made to the appended drawings wherein:

FIG. 1 is a top view of the Dandiya stick according to an embodiment of the present invention.

FIG. 2 is a cut-away view along line A-A of the Dandiya stick of FIG. 1.

FIG. 3 is a top view of the Dandiya stick according to another embodiment of the present invention.

FIG. 4 is a cut-away view along line B-B of the Dandiya stick of FIG. 3.

FIG. 5 is a cross-section along line C-C of the Dandiya stick of FIG. 3.

FIG. 6 is a schematic of the operation mode of the electronic circuit of the Dandiya stick of FIG. 1.

FIG. 7 is a top view of the Dandiya stick according to another embodiment of the present invention.

FIG. 8 is a cut-away view along line D-D of the Dandiya stick of FIG. 7.

### DETAILED DESCRIPTION OF THE INVENTION

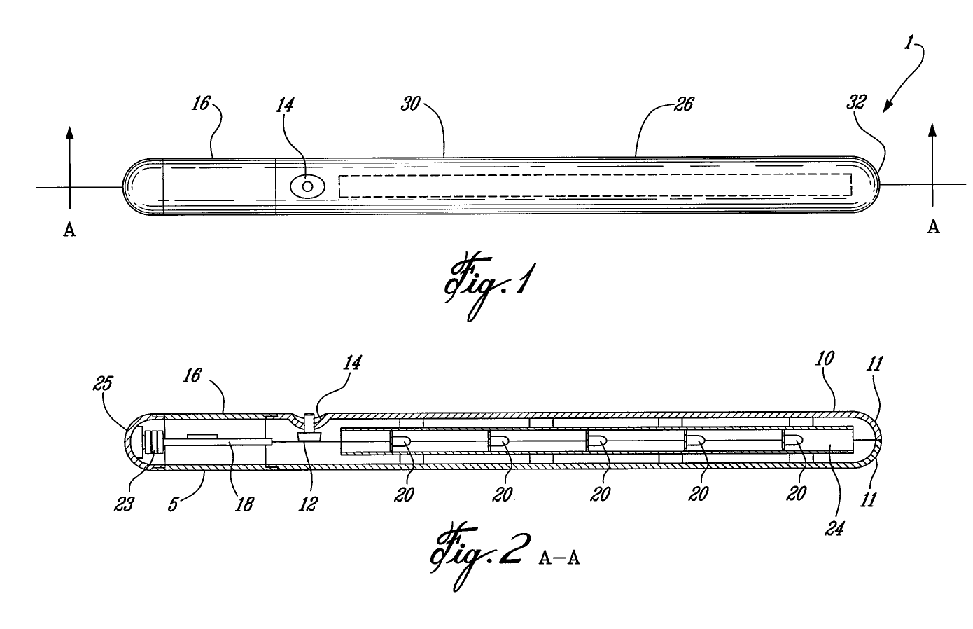

FIG. 1 and FIG. 2 depict the new Dandiya stick as used for either the traditional Dandiya Raas dance or Garba dance. The stick 1 comprises a body 5, which in the present embodiment is an outer shell 10. The outer shell 10 is made of two halves 11 held together by screws, adhesives or other know suitable attachment means. A translucent and impact resistant material is used for the shell 10. Preferably, polycarbonate is used. An on/off switch 12 is located within the shell 10, having its actuator protruding from a recess 14 in the shell 10. A grabbing portion 16 of the outer shell 10 holds an electronic circuit 18 that controls the lights 20, which are preferably leds (light emitting diodes). The lights 20 are placed within the two halves 11 of the outer shell 10, imbedded in the middle of the body 5. The lights 20 are placed in a semi-transparent shade 22, used to diffuse the light emitted by the lights 20. The shade 22 is held in place by circumferential rings 24. The lights 20 may be of any color. Batteries 23, also located within the grabbing portion 16, are used to power the electronic circuit 18 and the lights 20. The grabbing portion 16 is equipped with an access cover 25 to provide access to the batteries 23.

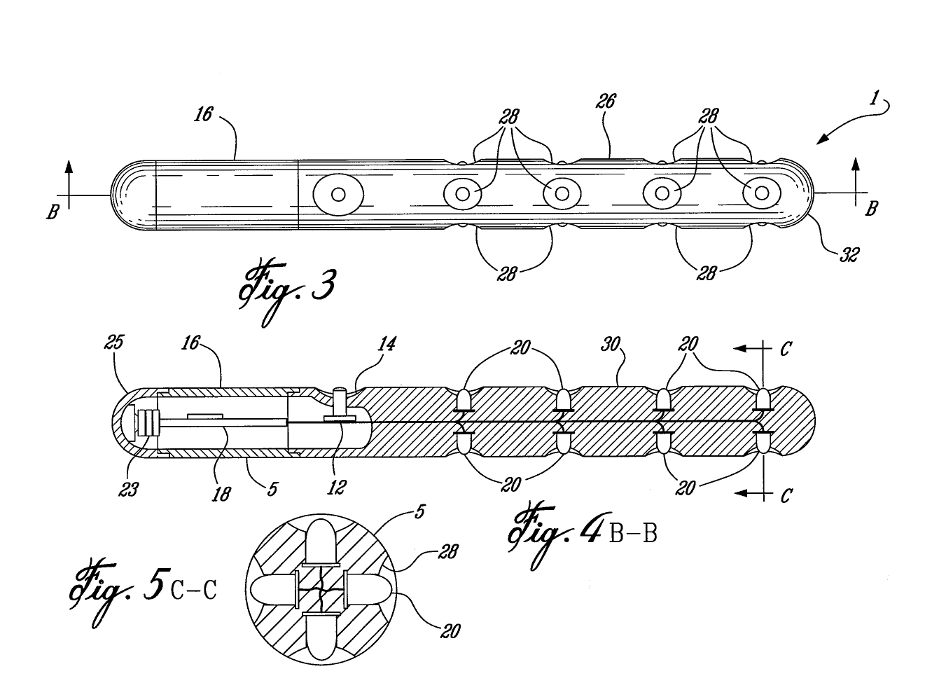

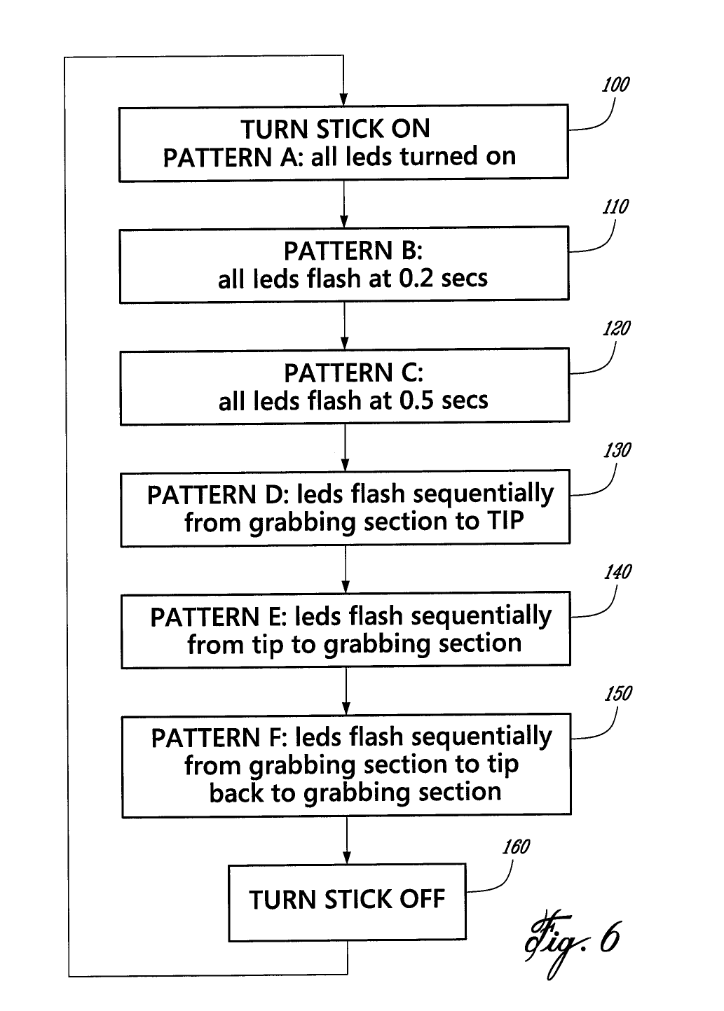

FIGS. 3, 4 and 5 depict different views of a second embodiment of the new Dandiya stick. The stick 1 comprises a body 5. The grabbing portion 16 of this embodiment is similar to that of the previous embodiment. However, the striking portion 26 is solid instead of being hollow as in the previous embodiment. This allows the lights 20 to be directly imbedded in and held in place by the material of the body 5. The lights 20 are located in led recesses 28 if the body material is opaque and does not transmit light. However, if the material of the body 5 is a translucent material, then the lights 20 may be completely embedded in the material. The batteries 23, the electronic circuit 18, the on/off switch 12 and the lights 20 are interconnected and function exactly the same way as previously described. The grabbing portion 16 is also equipped with an access cover 25 to provide access to the batteries 23.

Conveniently, in both embodiments, the lights 20 are placed recessed from the striking surface 30 of the striking portion 26. This prevents the lights 20 from being damaged by striking the Dandiya sticks 1 together.

In use, the user turns on the Dandiya stick 1 by depressing the on/off switch 12. The electronic circuit 18 lights up the lights 20 according to a first lighting pattern. A second depression of the on/off switch 12 makes the electronic circuit 18 turns on the lights 20 according to a second light pattern. Many such patterns may be programmed in the electronic circuit 18 such that each further depression of the on-off switch 12 commands a different lighting pattern from the electronic circuit 18. A further depression of the on/off switch 12 turns the Dandiya stick off. FIG. 6 schematically shows the cycle used by the electronic circuit 18. Each further pattern is selected by pressing the on/off switch 12. The number of patterns may vary according to the preferences of the manufacturer but is preferably kept under ten since the user has to cycle them all to turn off the Dandiya stick. Optionally, the Dandiya stick 1 may be used with two switches, one on/off switch and one for selecting the lighting patterns.

Referring to FIG. 6, the activation of the on/off switch 12 turns on the Dandiya stick 1 and turns all leds on, as per pattern A 100. A second activation of the on/off switch 12 selects pattern B 110 where all leds flash rapidly (0.2 seconds). A third activation of the on/off switch 12 selects pattern C 120, flashing all leds slowly (0.5 seconds). A fourth activation of the on/off switch 12 selects pattern D 130, flashing the leds sequentially from the led closer to the grabbing portion 16 to the led closer to the tip 32 of the Dandiya stick 1. A fifth activation of the on/off switch 12 selects pattern E 140, flashing the leds sequentially from the led closer to the tip 32 of the Dandiya stick 1 to the led closer to the grabbing portion 16. A sixth activation of the on/off switch 12 selects pattern F 150, flashing the leds sequentially from the led closer to the grabbing portion 16 to the led closer to the tip 32 of the Dandiya stick and back to the led closer to the grabbing portion 16. A seventh activation of the on/off switch 12 turns off the lights 160 of the Dandiya stick 1.

The Dandiya stick of the present invention is impact resistant due to its use of polycarbonate. In use, the user strikes one Dandiya stick against another on their striking portion 26. Advantageously, concealing the electronic components within the grabbing portion 16 keeps them away from the impacts. It has also be found that equipping the electronic circuit 18 with a capacitor, such as a capacitor of 47 μF helps in maintaining the lights 20 constantly lit through impacts. The capacitor acts as a buffer of energy to power the lights 20 during the impacts. The electronic circuit 18 is a long strip having holes receiving the lights 20 such that they can illuminate both sides of the electronic circuit 18.

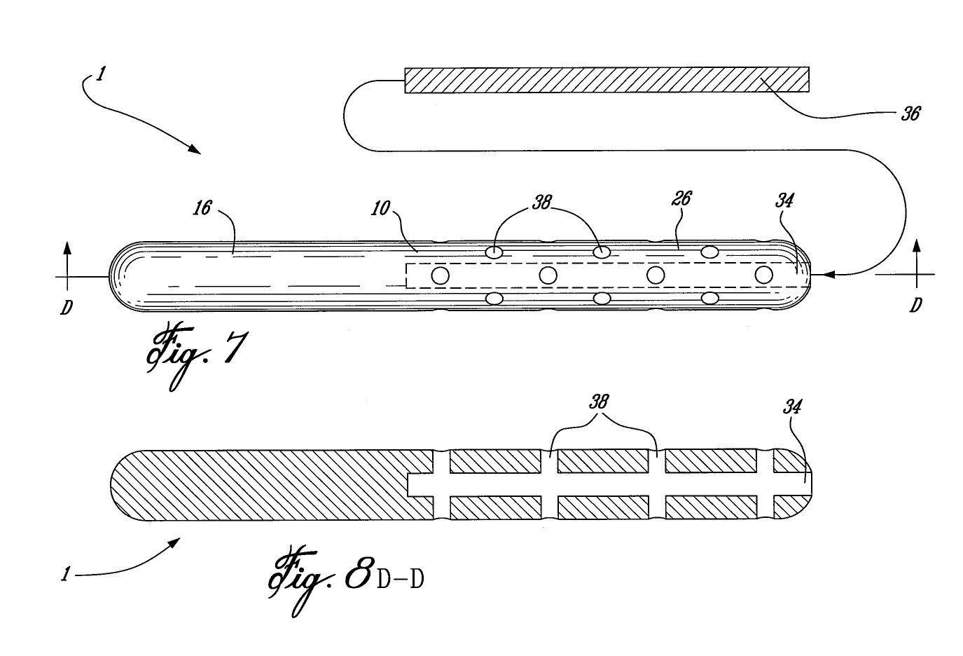

Referring now simultaneously to FIGS. 7 and 8, there is depicted yet another embodiment of the present invention. Shown here is the Dandiya stick 1 with its outer shell 10, the grabbing portion 16 and the striking portion 26. The outer shell 10 is provided with a cavity 34 for inserting a chemiluminescent tube 36. The chemiluminescent tube 36 is a disposable tube containing a chemical liquid having luminescent properties such that upon activation, the chemiluminescent tube 36 lights up for a period of time, normally for a few hours. When the chemiluminescent tube stops fades away and stops lighting, it may be readily replaced by a brand new chemiluminescent tube 36. The light produced by the chemiluminescent tube 36 escapes from inside the Dandiya stick 1 through a multitude of orifices 38. The orifices may take many shapes such as slots or holes. This is a low cost alternative as no electronic parts are necessary.

It will of course be appreciated that many modifications and alternative embodiments are possible within the broad scope of the present invention. For example, the body could be made of either a single part or a plurality of parts. For example, it will be readily apparent to a person skilled in the art that a multitude of different patterns may be generated. An impact-sensitive device may also be used to detect impacts of the two sticks together such that the electronic circuit generate a pattern accordingly, simulating an impact, or just flashing the lights 20 in any desired pattern. Furthermore, the light source the number and the color of lights 20 may be varied. For example, a single light source could be used close to the grabbing portion 16 and optic fibers could be used to bring the light in the striking portion 26. A pattern could be created with a single light source. For example, the single light source may be flashed according to a specific rhythm or sequence, such as Morse. Moreover, different materials, or a combination of different materials may be used for the stick. For example, wood, metal or composite materials may be used. An outer shell of metal may also be combined with an outer shell of polycarbonate, for example, providing different sound characteristics depending on which half is stricken.

The present invention has been described with regard to preferred embodiments. The description as much as the drawings were intended to help the understanding of the invention, rather than to limit its scope. It will be apparent to one skilled in the art that various modifications may be made to the invention without departing from the scope of the invention as described herein, and such modifications are intended to be covered by the present description.

We claim:

1. A light stick for use in a traditional dance comprising:
an elongated impact resistant body having an striking surface;
at least one light source imbedded in said body, said at least one light source being placed set back from said striking surface,
wherein said body is at least partly permeable to a light coming from said light source.

2. A light stick as defined in claim 1 wherein said light source is chemiluminescent.

3. A light stick as defined in claim 1 further comprising an electronic circuit for controlling said at least one light source and a power source for powering said electronic circuit and said at least one light source, said electronic circuit and said power source being contained within said body.

4. A light stick as defined in claim 3 wherein said electronic circuit controls said at least one light such as to create a lighting pattern.

5. A light stick as defined in claim 4 wherein said at least one light source is made of light emitting diodes.

6. A light stick as defined in claim 5 wherein said body has openings to let said light come out.

7. A light stick as defined in claim 5 wherein said body is translucent.

8. A light stick as defined in claim 7 wherein said at least one light source is completely imbedded in said body.

9. A light stick as defined in claim 8 wherein said body comprises a solid striking portion.

10. A light stick as defined in claim 9 wherein said body has a circular cross-section.

11. A light stick as defined in claim 5 further comprising a semi-transparent shade containing said at least one light source.

12. A light stick as defined in claim 4 wherein said body is at least partly made of a material selected from the list consisting of polycarbonate, glass fiber, metal and wood.

13. A method of providing a special effect to a traditional dance comprising providing an impact-resistant lighting stick.

14. A method as defined in claim 13 further comprising illuminating a surface of said impact-resistant stick with imbedded lights.

15. A method as defined in claim 14 further comprising the step of making said lighting stick flash.

16. A method as defined in claim 15 further comprising the step of making lights of said lighting stick flash in a pattern.

17. A method as defined in claim 16 further comprising the step of making lights of said lighting stick sequentially flash from a proximate end to a distal end of said stick.

18. A method as defined in claim 14 further comprising the step of striking said stick against another of said stick.

19. A method as defined in claim 18 further comprising the step of making said lighting stick flash on impact.

20. A method as defined in claim 14 wherein said traditional dance is Raas dance and said stick is a Dandiya stick.

21. The use of a light stick as defined in claim 1 in a traditional dance.

22. The use of a light stick as defined in claim 20 wherein said dance is selected from the group consisting of Raas and Garba.
